(19) United States
(12) Patent Application Publication
(10) Pub. No.: US 2025/0164417 A1
(43) Pub. Date: May 22, 2025

(54) ELECTRIC WIRE FIXING JIG, CRIMPING DETERMINATION DEVICE, AND CRIMPING DETERMINATION METHOD

(71) Applicant: Kabushiki Kaisha Toshiba, Tokyo (JP)

(72) Inventors: Akira TANAKA, Yokohama Kanagawa (JP); Juhong YANG, Akishima Tokyo (JP); Emi SATO, Machida Tokyo (JP)

(21) Appl. No.: 18/933,736

(22) Filed: Oct. 31, 2024

(30) Foreign Application Priority Data
Nov. 20, 2023 (JP) 2023-196641

(51) Int. Cl. G01N 23/046; G01N 23/083; G01N 23/18; H01R 43/048

(52) U.S. Cl. CPC G01N 23/046; G01N 23/083; G01N 23/18; G01N 2223/645; H01R 43/048

(57) ABSTRACT

According to one embodiment, an electric wire fixing jig for X-ray CT imaging of a wire harness has a base portion of a material that transmits imaging X-rays and a groove. The groove extends depthwise in a first direction into a first surface of the base portion. The groove has a width in a second direction along the first surface of the base portion that is greater than a diameter of a wire of the wire harness. The groove extends lengthwise in a third direction through a pair of facing outer surfaces of the base portion.

### CROSS-REFERENCE TO RELATED APPLICATION

This application is based upon and claims the benefit of priority from Japanese Patent Application No. 2023-196641, filed Nov. 20, 2023, the entire contents of which are incorporated herein by reference.

### FIELD

Embodiments described herein relate generally to an electric wire fixing jig, a crimping determination device, and a crimping determination method.

### BACKGROUND

In wiring of an electronic device, a wire harness in which a crimp terminal is crimped to an electric wire can be used for connection to a high-wattage element such as a power supply. In such a wire harness, if the crimp terminal is not sufficiently crimped to the electric wire, the resistance increases due to oxidation of the electric wire or partial disconnection of the electric wire. In such cases, there is a risk of excessive heating and smoke generation. Therefore, whenever using a wire harness, it is necessary to accurately determine the quality of the crimping for the individual component wires. In many cases, although an X-ray computed tomography (CT) image of a cross section of a wire harness may be used to determine the quality of the crimping state, it takes time to acquire such an image. Therefore, it will take a long time to determine the crimping state of a large number of electric wires.

### BRIEF DESCRIPTION OF THE DRAWINGS

FIG. 1 is a schematic diagram of a crimping determination device according to a first embodiment.

FIG. 2 is a schematic diagram of a wire harness according to a first embodiment.

FIG. 3 is a diagram schematically showing aspects related to a method for obtaining a porosity from an X-ray CT image according to a first embodiment.

FIGS. 4A and 4B are schematic diagrams of an electric wire fixing jig for X-ray CT imaging according to the related art.

FIGS. 5A and 5B are schematic diagrams of an electric wire fixing jig for X-ray CT imaging according to a first embodiment.

FIGS. 6A to 6D are schematic diagrams of an electric wire fixing portion of an electric wire fixing jig for X-ray CT imaging according to a first embodiment.

FIGS. 7A to 7F are schematic diagrams showing other examples of an electric wire fixing jig for X-ray CT imaging according to a first embodiment.

FIG. 8 is a flowchart of a crimping determination method according to a first embodiment.

FIG. 9 is a cross-sectional view of a crimping portion according to a first embodiment.

FIG. 10 is a flowchart showing another example of a crimping determination method according to a first embodiment.

### DETAILED DESCRIPTION

Embodiments relate to an electric wire fixing jig, a crimping determination device, and a crimping determination method that are capable of determining a crimping state of an electric wire in a time-efficient manner.

In general, according to one embodiment, an electric wire fixing jig for X-ray CT imaging of a wire harness includes a base portion. The base portion is a material that transmits imaging X-rays. A groove extends depthwise in a first direction into a first surface of the base portion> The groove has a width in a second direction along the first surface of the base portion that is greater than a diameter of a wire of the wire harness. The groove extends lengthwise in a third direction through a pair of facing outer surfaces of the base portion.

Hereinafter, a crimping determination device, an electric wire fixing jig, and a crimping determination method according to certain example embodiments will be described with reference to the drawings.

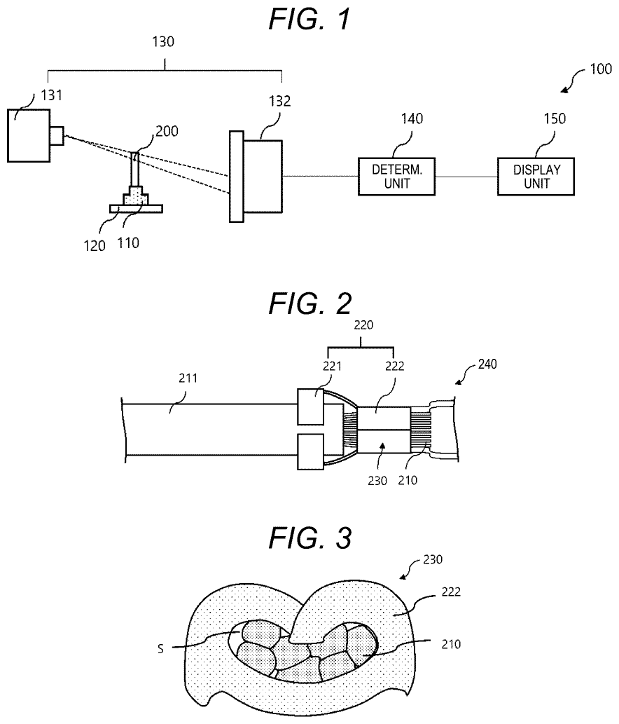

FIG. 1 schematically shows a configuration of a crimping determination device 100 according to a first embodiment. The crimping determination device 100 images a plurality of wire harnesses 200 at the same time or in rapid succession and determines a crimping state quality (crimped state) in the crimping portion 230 (see FIG. 2) in a wire harness 200. The crimping determination device 100 includes an electric wire fixing jig 110 (jig 110) that fixes the wire harness 200 to be imaged in position, a stage 120 for the jig 110 in the crimping determination device 100, an imaging unit 130 that provides images of the wire harness 200, a determination unit 140 that determines a crimped state of the crimping portion 230 by using an image captured by the imaging unit 130, and a display unit 150 that displays a determination result of the crimped state in the crimping portion 230.

First, the wire harness 200 will be described. FIG. 2 schematically shows one of the wires 210 of a wire harness 200 according to the first embodiment. The wire harness 200 includes a plurality of electric wires 210 (which may have individual strands therein) with a crimp terminal 220 attached to tip ends of each of the electric wires 210. The electric wire 210 can be, for example, a metal such as aluminum, copper, or a copper alloy. The electric wire 210 can be a solid wire or comprise individual strands (sub-wires) or the like as depicted. Part of the electric wire 210 can be coated with an insulating coating member 211. The crimp terminal 220 can be, for example, a metal such as aluminum, copper, or a copper alloy, or a metal plated surface. The crimp terminal 220 has a first mounting portion 221 that attaches to the coating member 211 and a second mounting portion 222 attaches to the bare electric wire 210. The first mounting portion 221 is fixed to the coating member 211 by crimping to surround (or substantially so) the outer periphery of the coating member 211. The second mounting portion 222 is fixed to the bare electric wire 210 by crimping to surround (or substantially so) the outer periphery of the bare electric wire 210. The wire harness 200 has a crimping portion 230 near a connector end 240 of the electric wire 210.

The jig 110 fixes the wire harness 200 to be imaged so as to be perpendicular to the stage 120. The jig 110 is formed of a material that transmits X-rays, and for example, a resin or aluminum may be used. The jig 110 includes an electric wire fixing portion 111 that fixes to a portion of a wire harness 200 near the crimping portion 230, a wire arranging portion 112 that holds a portion of the wire harness 200 other than the portion near the crimping portion 230, and a column 113 that fixes the electric wire fixing portion 111 to the stage 120 of the crimping determination device 100. However, in some examples, the wire harness 200 may be able to be sufficiently fixed to the stage 120 without using the wire arranging portion 112 or the column 113, and the jig 110 may need to include only the electric wire fixing portion 111.

The stage 120 supports the electric wire fixing portion 111 from below in the vertical direction.

The imaging unit 130 images the wire harnesses 200. The imaging unit 130 may be, for example, an oblique X-ray CT apparatus and acquires a cross-sectional image of a wire harness 200 as an X-ray CT image. The imaging unit 130 may include an optical system such as an X-ray generator 131, an X-ray detector 132, along with lenses, beam shaping equipment, or the like, and is disposed to be able to image the wire harness 200 when such is fixedly disposed on the stage 120.

The determination unit 140 collects images of the wire harness 200 provided by the imaging unit 130 and determines a crimped state of the crimping portion 230 of the wire harness 200. Specifically, a porosity of the crimping portion 230 is calculated from the X-ray CT image of the crimping portion 230. FIG. 3 schematically shows aspects of a method for obtaining a porosity value from a X-ray CT image according to the first embodiment. In this context, porosity refers to a ratio of a space outside the electric wire 210, that is, a ratio of the space S to the total space enclosed by the second mounting portion 222 in a cross section of the crimping portion 230. The image having the smallest porosity can be extracted from the captured cross-sectional X-ray CT images of the wire harnesses 200, and using the X-ray CT images having the smallest porosity, the crimped state quality determination as to whether the second mounting portion 222 is sufficiently crimped to the electric wire 210 is performed. Alternatively, before determining the quality of the crimped state, it may be determined whether the imaging conditions for the X-ray CT image captured by the imaging unit 130 are appropriate or inappropriate. Here, an appropriate imaging condition means that the focus of the cross section of the crimping portion 230 is appropriately positioned or set, the brightness of the image is appropriate, and the like. When an imaging condition is inappropriate, a change of the imaging condition, a reselection of the electric wire fixing portion 111, or the like can be performed, and the X-ray CT imaging of the crimping portion 230 can be performed by the imaging unit 130 again. The determination unit 140 may be provided in the crimping determination device 100 or may be provided outside the crimping determination device 100. For example, the determination unit 140 may be a computer, and, in general, any device with an arithmetic element or the like, such as a central processing unit (CPU), and a storage element, such as a semiconductor memory, can be used.

The display unit 150 displays a determination result of the crimped state quality of the crimping portion 230 from the determination unit 140. For example, the display unit 150 may be a liquid crystal display that displays pictures, images, graphics, or the like.

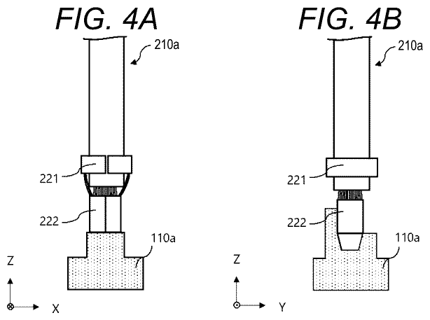

Next, the jig 110 will be described. In the wire harness 200, when the second mounting portion 222 is not sufficiently crimped to the electric wire 210, a situation occurs in which a portion of the wire harness is exposed to the atmosphere or surrounding corrosive gases. As a result, the resistance value in the wire harness 200 increases due to oxidation or possible disconnection of the electric wire 210, and there is a risk of excessive heating or even fire or smoke generation. Therefore, in the wire harness 200, the quality determination concerning whether the second mounting portion 222 is sufficiently crimped to the electric wire 210 may be performed using an X-ray CT image of a cross section of the crimping portion 230. In order to perform X-ray CT imaging on the crimping portion 230 of the wire harness 200, the wire harness 200 needs to be fixed to the stage 120 provided in the crimping determination device 100. The jig 110 is used as a jig for fixing the wire harness 200 to the stage 120. The jig 110 is made of a material that transmits X-rays. FIGS. 4A and 4B are schematic diagrams showing an electric wire fixing jig for X-ray CT imaging according to the related art. FIG. 4A shows a front view of the electric wire fixing jig 110a, and FIG. 4B shows a side view of the electric wire fixing jig 110a. The electric wire fixing jig 110a is capable of holding only one wire 210a at a time. In the X-ray CT imaging of the crimping portion 230 of the wire harness 200 with the related art, one wire 210a (the imaging target) is disposed on the electric wire fixing jig 110a, and the X-ray CT imaging of the crimping portion 230 is performed. As shown in FIG. 4A and FIG. 4B, the electric wire fixing jig 110a fixes the wire 210a in place by clamping of the tip portion of the wire 210a. The electric wire fixing jig 110a is fixed to the stage 120 of the crimping determination device 100, and the crimping portion 230 is imaged. In this case, one image of a crimping portion 230 of the wire harness 200 may be provided in one X-ray CT imaging.

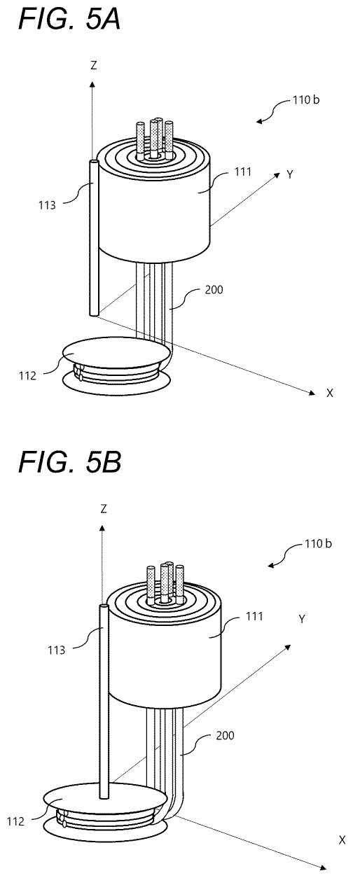

FIGS. 5A and 5B are schematic diagrams showing another electric wire fixing jig for X-ray CT imaging according to the first embodiment. The electric wire fixing jig 110b (jig 110b) includes an electric wire fixing portion 111 that fixes a portion of each electric wire 210 of a wire harness 200 near the second mounting portion 222, a wire arranging portion 112 that bundles the portion of the wire harness 200 (electric wires 210) not fixed to the electric wire fixing portion 111, and a column 113 that fixes (connects) the electric wire fixing portion 111 to the stage 120. The electric wire fixing portion 111 is fixed to a stage 120 (sample stage) via the column 113. The stage 120 may be a planar element or the like that move in an XY plane or the like to position samples for imaging. The column 113 holds the electric wire fixing portion 111 at a constant position on the stage 120. The electric wire fixing portion 111 may also hold a plurality of the wire harnesses 200. In order to prevent the wire harness 200 from being damaged when the plurality of wire harnesses 200 are fixed or an electric wire 210 of a wire harness 200 is repeatedly removed from the electric wire fixing portion 111 for imaging of the wire harness 200, it is desirable that the electric wire fixing portion 111 is formed of a material providing low dust, high wear resistance, and dimensional stability. For example, a silicone resin, a polyethylene resin, or the like may be used. Low dust generation helps prevents the accumulation of dust generated when attaching and detaching the wire harness 200 from damaging the electric wires 210 or obscuring the captured images.

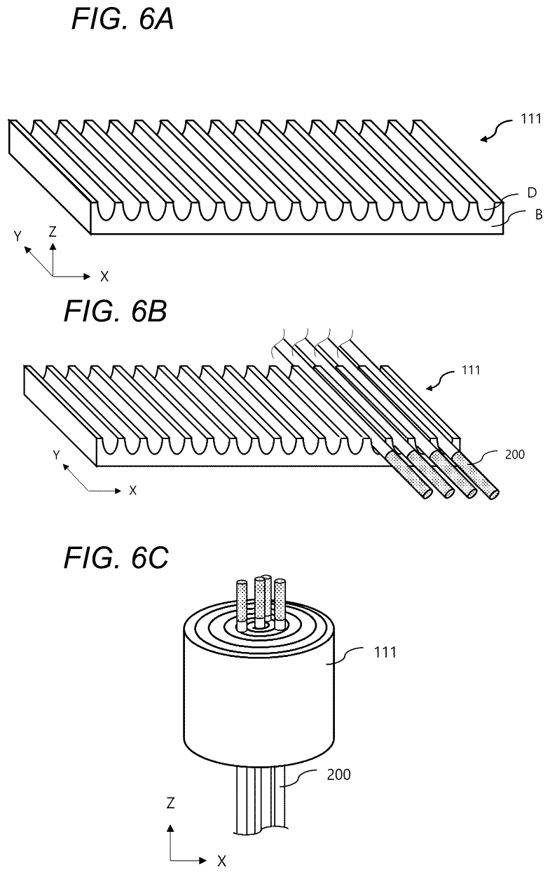

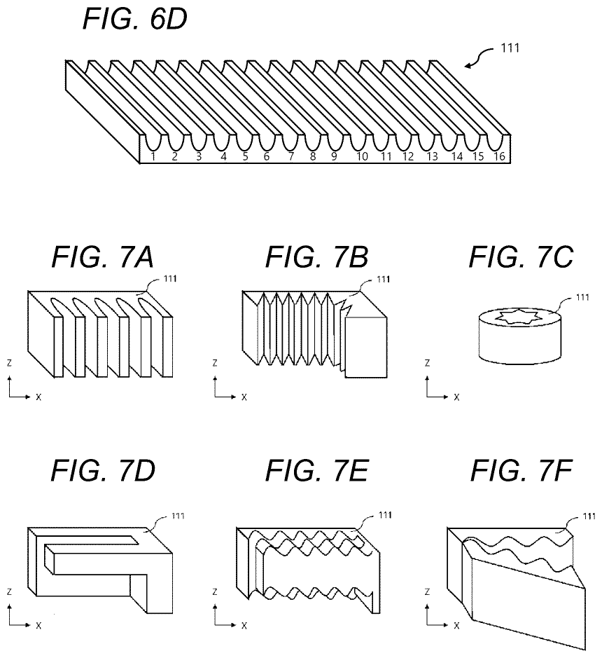

FIGS. 6A to 6D are schematic diagrams showing aspects of an electric wire fixing portion 111 of an electric wire fixing jig for X-ray CT imaging according to the first embodiment. FIG. 6A is a perspective view of an example of the electric wire fixing portion 111. FIG. 6B is a perspective view of the example of the electric wire fixing portion 111 in which a wire harness 200 is disposed. FIG. 6C is a schematic diagram of an example of the electric wire fixing portion 111 in which a wire harness 200 has been fixed. FIG. 6D is a perspective view of another example of an electric wire fixing portion 111.

The electric wire fixing portion 111 has a base portion B in which one or more grooves D for arranging the electric wires 210 of a wire harness 200 are formed. The base portion B is formed of a material that transmits X-rays, and for example, aluminum, plastic, rubber, or the like may be used. A plurality of grooves D are provided spaced from each along one direction of the base portion B. For example, as shown in FIG. 6A, the groove D may have a shape in which the groove D extends lengthwise in the Y-axis direction and depthwise in the Z-axis direction (a thickness direction of the base portion B). The groove D penetrates the end surfaces (XZ plane surfaces) of the base portion B. For example, the shape of the groove D may be a substantially semi-cylindrical shape or the like. The grooves D are provided in the base portion B spaced along the X-axis direction. In consideration of the ease of imaging, it is desirable that the electric wires 210 of the wire harnesses 200 not be in contact with each other, so that the grooves D may be provided at regular intervals in the X-axis direction sufficient to avoid contact between adjacent electric wires 210 of wire harnesses 200. Although 16 grooves D are provided in FIG. 6A, this is merely an example, and a plurality of grooves D may be provided in another manner such as in a member above the base portion B. It may be desirable that the width of the groove D in the X-axis direction be larger than the diameter of the electric wire 210 of a wire harness 200, and the depth of the groove D in the Z-axis direction also be larger than the diameter of the electric wire 210 of the wire harness 200. Since the width of the groove D in the X-axis direction is larger than the diameter of the electric wire 210 of the wire harness 200 and the depth of the groove D in the Z-axis direction is also larger than the diameter of the electric wire 210 of the wire harness 200, the electric wires 210 of the wire harness 200 may be disposed in the grooves D and thus the wire harness 200 may be stably fixed.

When the X-ray CT imaging of the wire harness 200 is to be performed, the electric wire 210 of the wire harness 200 is fitted into a groove D provided in the base portion B. When the electric wire 210 of the wire harness 200 is disposed in the groove D, the crimp terminal 220 is disposed so as not to be around the electric wire fixing portion 111 such that the X-rays can transmit through the crimping portion 230 of the wire harness 200 during X-ray CT imaging. Specifically, the second mounting portion 222 of the wire harness 200 is disposed to be outside the electric wire fixing portion 111. Since the groove D extends in the Y-axis direction, the Y-axis position of the crimp terminals 220 of a plurality of electric wires 210 of one or more wire harnesses 200 may be aligned by providing the second mounting portions 222 of the crimp terminals 220 to be at the opening end of the groove D. When the first mounting portion 221 of the crimp terminal 220 is held in the electric wire fixing portion 111 by the electric wire fixing portion being rolled up (see FIG. 6C), the wire harness 200 can be disposed without a gap to the grooves D by setting the diameter of each groove D equal to the diameter of the first mounting portion 221, and thus the height of each crimping portion 230 may be aligned when the electric wire fixing portion 111 is fixed to the stage 120. Alternatively, when the first mounting portion 221 of the crimp terminal 220 is not accommodated in the electric wire fixing portion 111 by having the electric wire fixing portion rolled up (see FIG. 6C), the wire harness 200 can be disposed without a gap to the groove D by setting the diameter of the groove D equal to the diameter of the electric wires 210 of the wire harnesses 200, and thus the height of each crimping portion 230 may be aligned when the electric wire fixing portion 111 is fixed to the stage 120 since the position of the first mounting portion 221 of the plurality of wire harnesses 200 is aligned in the Y-axis direction. After the wire harness 200 is disposed on the base portion B, the electric wire fixing portion 111 can be rolled up in a direction (in the X-axis direction in FIG. 6B) orthogonal to the wire harness 200 to accommodate the wire harnesses 200 in a more compact manner. The disposition interval between the wire harnesses 200 and/or individual electric wires 210 may be adjusted width by more tightly winding or loosely rolling (winding) the electric wire fixing portion 111.

As shown in FIG. 6C, an electric wire fixing portion 111 now accommodating a wire harness 200 is now erect with respect to the XY plane and when fixed to the stage 120 of the X-ray CT apparatus. In order to fix the electric wire fixing portion 111 to the stage of the X-ray CT apparatus, the column 113 is used with the electric wire fixing portion 111. The column 113 is provided on a surface of the electric wire fixing portion 111 on which grooves D are not provided, and is fixed to the X-ray CT apparatus such that the wire harness 200 will be perpendicular to the stage surface of the X-ray CT apparatus. The column 113 is formed of a material that transmits X-rays.

Considering that a plurality of wire harnesses 200 may be disposed in the electric wire fixing portion 111, in order to distinguish the wire harnesses 200 (and/or individual electric wires 210) at the time of analysis of the captured X-ray CT image(s), numbering or the like may be performed with a material that does not transmit X-rays in the vicinity of each groove D of the electric wire fixing portion 111 as shown in FIG. 6D. By performing this numbering, it is possible to identify and select a specific wire harness 200 and/or electric wire 210 which is determined non-defective or defective in the quality determination performed by determination unit 140.

The shape of the electric wire fixing portion 111 shown in FIGS. 6A to 6D is one example, and the electric wire fixing portion 111 is not limited to this shape. The wire harness 200 may be fitted into a groove D and may have a shape that is capable of being fixed to the base portion B. FIGS. 7A to 7F are schematic diagrams showing other examples of an electric wire fixing jig for X-ray CT imaging according to the first embodiment. FIGS. 7A to 7C each show a case where a plurality of grooves D are provided in the base portion B. FIGS. 7D to 7F show cases with other arrangements.

A plurality of substantially semi-cylindrical grooves D may be provided on the base portion Bas shown in FIG. 7A.

A plurality of triangular columnar grooves D may be provided on the base portion B and form an L-shape as shown in FIG. 7B. The shape of the groove D is not limited to a substantially cylindrical shape or a triangular column shape, and may have a columnar shape, such as a rectangular column or an elliptical column.

As shown in FIG. 7C, the shape of a through portion formed in the electric wire fixing portion 111 may have a star-shaped polygonal shape, and the electric wires 210 of a wire harness 200 may be inserted into a groove D at a vertex of the star-shaped polygonal shape. FIG. 7C depicts a ring-shaped base portion 111. More specifically, in FIG. 7C, the through portion has a star-shaped heptagon shape, and a wire harness 200 or its electric wires 210 may be inserted into any one of the seven vertex portions (grooves D). A groove D may have a shape as shown in FIG. 7C. The opening for the groove D can be polygonal.

Alternatively, as shown in FIG. 7D, a space for passing the wire harness 200 through XZ planar surface and penetrating in the Z-axis direction (thickness direction) may have a shape in which the space is separated by a straight, linear portion.

As shown in FIG. 7E, in another example, one or more wavy line portion or surface may be provided in the electric wire fixing portion 111. Further, as shown in FIG. 7F, the electric wire fixing portion 111 may be openable and closable and, in some examples, the two opening/closing portions that can be separated from each other may meet at a wavy interface or boundary. Since electric wire fixing portion 111 is openable and closable in this example, a wire harness 200 of different wire diameters may be fixed to the same electric wire fixing portion 111.

As shown in FIGS. 7E and 7F, a groove D formed by having a wavy surface can be formed in the electric wire fixing portion 111. Although the wavy surface is present in the electric wire fixing portion 111, it may be desirable to consider the ease of arranging of the wire harnesses 200 in a straight line in than the electric wire fixing portion 111. This is because, since the wire harness 200 is formed of a material with stiffness, when the boundary between the groove D and the base portion B is simply straight, the portion of the wire harness 200 in contact with the groove D will be along a plane, and the wire harness 200 or individual wires 210 may fall or slide when the wire harness 200 is inserted in the electric wire fixing portion 111, but when wire harness 200 is in contact with a wavy surface, the movement of the wire harness 200 when the wire harness 200 is inserted in the electric wire fixing portion 111 may be prevented. Desirably, one electric wire 210 of a wire harness 200 may be disposed in each groove D as shown in FIGS. 6A to 7B, in consideration of the ease of inserting and handling as well as the stability of the wire harness 200 once inserted into grooves D or the like.

The wire arranging portion 112 bundles the electric wires 210 of a wire harness 200 and/or multiple wire harnesses 200. The wire arranging portion 112 can be provided at a position where X-rays emitted from the X-ray generator 131 of the imaging unit 130 do not transmit. When the wire harness 200 is fixed to the stage 120 using the electric wire fixing portion 111, a part of the wire harness 200 may overlap the first quadrant since the wire harness 200 may have a long total length. When the wire harness 200 portions other than the crimping portion 230 are present in the first quadrant and the electric wires 210 in the wire harness 200 does not transmit X-rays, an X-ray CT image including a portion of the wire harness 200 other than the crimping portion 230 may be imaged. When the image including a portion other than the crimping portion 230 is used for a crimped state quality determination performed by the determination unit 140, there is a possibility that it takes up time during image extraction or a possibility that an inappropriate image will be extracted. Therefore, a wire arranging portion 112 that bundles the wire harness 200 is used so that the wire harness 200 portions other than the crimping portion 230 do not overlap the transmission path (first quadrant) of the X-ray (or do not significantly overlap the transmission path). A portion of the wire harness 200 that is not itself fixed to the electric wire fixing portion 111 out can be wound around a spool or spool-like portion of the wire arranging portion 112 to bundle the portions of the wire harness 200 not being imaged. By using the wire arranging portion 112, it is possible to prevent the X-rays emitted from the X-ray generator 131 from transmitting through a wiring harness portion other than the crimping portion 230. However, depending on the type of the wire harness 200 or the like, the wire arranging portion 112 may not need to be used to avoid imaging of the other wire harness 200 portions.

The column 113 (a columnar support) fixes the electric wire fixing portion 111 to the stage 120. When the electric wire fixing portion 111 is used, the wire harness 200 may protrude downward in the vertical direction from the fixing jig, and it may be difficult to fix the wire harness 200 to the stage 120 only by use of the electric wire fixing portion 111. Therefore, the column 113 is used to fix (attach) the electric wire fixing portion 111 to the stage 120. The column 113 may be attached in advance to a surface of the electric wire fixing portion 111 or may be connected to the electric wire fixing portion 111 when the electric wire fixing portion 111 is to be fixed to the stage 120. For example, as shown in FIG. 5A, when the electric wire fixing portion 111 is rollable, the electric wire fixing portion 111 may be fixed to a predetermined position on the stage 120 by connecting the column 113 to the outermost peripheral portion of the rolled electric wire fixing portion 111 so as to be substantially parallel to the wire harness 200 accommodated in the electric wire fixing portion 111. The column 113 may then be inserted into a hole provided in the stage 120. In this case, the column 113 may be provided in parallel with the grooves D. When the electric wire fixing portion 111 is not rollable, the column 113 may be attached in advance to any surface portion of the electric wire fixing portion 111 on which the groove D is not provided or may be connected to the electric wire fixing portion 111 when the electric wire fixing portion 111 is being fixed to the stage 120. The column 113 extends in the vertical direction (Z-axis direction) and is physically connected to both the electric wire fixing portion 111 and the stage 120. However, as shown in FIG. 5B, the column 113 may be disposed on the wire arranging portion 112 to be substantially parallel to the wire harness 200. By providing the column 113 on the wire arranging portion 112, the column 113 may be fixed to the stage 120 without providing a hole or the like for fixing the column 113 in the stage 120. The column 113 is desirably formed of a material that does not interfere with X-ray CT imaging, and for example, a plastic or aluminum may be used. However, when an electric wire fixing portion 111 that may be fixed to the stage 120 without a column 113 is used, the electric wire fixing portion 111 may be fixed to the stage 120 in some other manner without using the column 113.

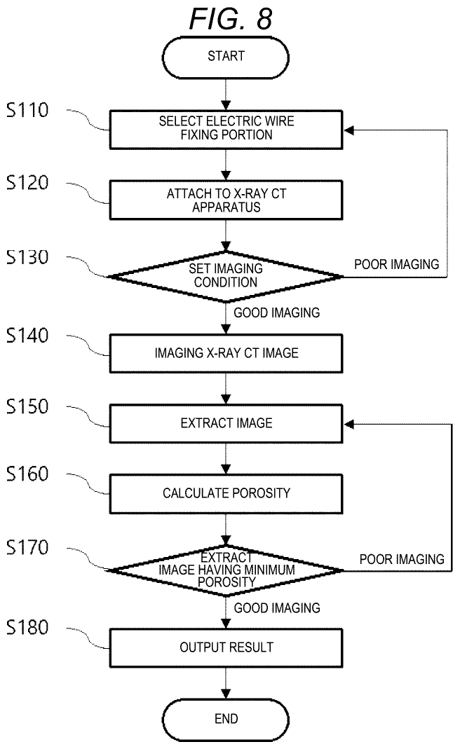

Next, a crimping determination method will be described. FIG. 8 shows a flowchart of a crimping determination method according to the first embodiment.

First, in step S110, an electric wire fixing portion 111 is selected. An appropriate electric wire fixing portion 111 is selected according to the number, the diameter, and the like of the electric wires 210 of wire harnesses 200 to be tested for determining the crimped state. After the electric wire fixing portion 111 is selected, the process proceeds to step S120.

In step S120, the wire harness 200 is attached to the imaging unit 130. Specifically, the wire harness 200 is fixed to the stage 120 of the X-ray CT apparatus. Before the wire harness 200 is attached to the stage 120, the wire harness 200 is first fixed to the electric wire fixing portion 111 selected in step S110, and the electric wire fixing portion 111 is then fixed to the stage 120. When the wire harness 200 is fixed to the electric wire fixing portion 111, the plurality of crimping portions 230 are fixed so that the heights thereof are aligned to each other. When the column 113 is necessary to fix the electric wire fixing portion 111 to the stage 120, the electric wire fixing portion 111 is fixed by using the column 113. After the electric wire fixing portion 111 is fixed to the stage 120, a portion of the wire harness 200 not fixed to the electric wire fixing portion 111 can be wound around the wire arranging portion 112 and fixed to a position outside the stage 120 or disposed to avoid as much as possible the X-rays. After the wire harness 200 is attached to the X-ray CT apparatus, the process proceeds to step S130.

In step S130, the imaging conditions of the imaging unit 130 are set, and it is determined whether the currently set imaging conditions are appropriate or inappropriate. Specifically, the X-ray irradiation intensity of the X-ray CT apparatus, the number of images to be captured, and the like are set, and a test imaging may be performed. As a result of the test imaging, if the imaging conditions are considered appropriate, the target image may be acquired without any defects in imaging. On the other hand, when the imaging conditions are considered inappropriate, it will be difficult to acquire the target image without imaging defects. Here, a case where the imaging condition is inappropriate will be described. It can be determined that the imaging condition is inappropriate when the acquired image has a portion where the crimping portion 230 overlaps, a portion where the contrast of the image is ambiguous, a portion where the image is out of focus, or the like, such that it may be difficult to determine the crimped state quality. Therefore, when the imaging condition is appropriate and the imaging is good, the process proceeds to step S140, but when the imaging condition is inappropriate or the imaging is poor, the process returns to step S110.

In step S140, the X-ray CT imaging of the wire harness 200 fixed to the stage 120 is performed. For example, when ten wire harnesses 200 are fixed to the electric wire fixing portion 111, the ten wire harnesses 200 are imaged in one X-ray CT imaging process, and X-ray CT images including the ten wire harnesses 200 are acquired. In order to distinguish the imaged wire harnesses 200, numbering can be performed on the image, or when numbering is not performed on the image, a numbered fixing jig 110 may be used. After the X-ray CT imaging of the wire harness 200 is performed, the process proceeds to step S150.

In step S150, a plurality of images related to the crimping portion 230 are extracted from the captured X-ray CT images. Approximately 200 to 300 tomographic images are acquired for each location of the crimping portion 230. After an image of the crimping portion 230 is extracted, the process proceeds to step S160.

In step S160, a porosity of each extracted tomographic image of the crimping portion 230 is calculated. The porosity is calculated by distinguishing void portions from the electric wires 210 using a contrast difference or the like. After the porosity is calculated from each extracted image, the process proceeds to step S170.

In step S170, the image having the minimum calculated porosity is extracted, and a shape of the crimping portion 230 captured in the extracted image is determined. After the shape of the crimping portion 230 is determined, the process proceeds to step S180.

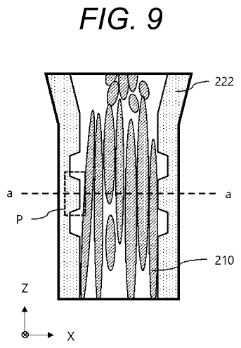

Here, the reason for extracting the image having the minimum porosity will be described. FIG. 9 shows a cross-sectional view of a crimping portion 230 according to the first embodiment. FIG. 9 shows a cross-sectional view in the XZ plane. Generally, the second mounting portion 222 of the crimp terminal 220 is provided with an uneven portion. When the crimp terminal 220 is crimped to the electric wire 210, it is desirable that a portion of the second mounting portion 222 having a protrusion P (serration) therein be crimped, and in particular, the protrusion P be sufficiently crimped. Even when the second mounting portion 222 is not fully crimped but at least one portion is sufficiently crimped so that there is no gap, the crimped state may be determined to be good as a whole in the wire harness 200. When the portion of the second mounting portion 222 having a protrusion P therein is crimped, the a-a cross-sectional image of the crimping portion 230 near the protrusion P has the minimum porosity, and the shape of the most suitable portion for determination may be viewed to determine the crimped state quality. Therefore, an image having a minimum porosity is extracted.

In step S180, the determination result of the shape of the crimping portion 230 performed in step S170 is output. After the determination result is displayed on the display unit 150, the process is ended.

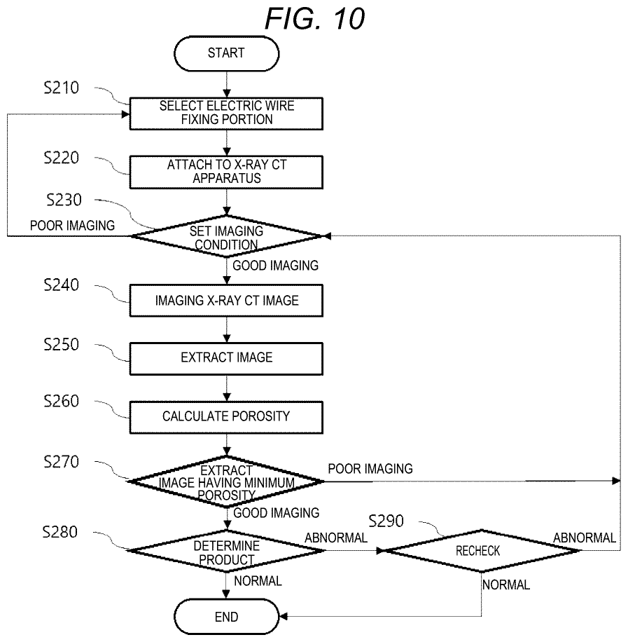

FIG. 10 is a flowchart showing another example of a crimping determination method according to the first embodiment. In steps S210 to S260, the same steps in steps S110 to S160 described above are performed.

In step S270, an image having the minimum porosity is extracted. A tomographic image having the smallest porosity of the crimping portion 230 is extracted from the captured tomographic images. After the image having the minimum porosity is extracted, the process proceeds to step S290.

In step S290, product determination is performed. In the product determination, the crimped state quality of the crimping portion 230 is determined. Specifically, it is determined whether the crimped state of the crimp terminal 220 to the electric wire 210 is sufficient (normal) or not (abnormal). When the crimping of the crimp terminal 220 to the electric wire 210 is normal and the wire harness 200 is mounted on the product, it is considered that the risk of smoke being generated by the crimping portion 230 of the wire harness 200 or the like during use of the product is low and the product will be safe. On the other hand, when the crimping of the crimp terminal 220 to the electric wire 210 is abnormal and the wire harness 200 is mounted on the product, the resistance value may increase due to the oxidation of the electric wire 210, the disconnection of the electric wire 210 from the crimping portion 230, or the like, and there is a risk of excessive heating and smoke generation. Therefore, when the crimping of the crimp terminal 220 to the electric wire 210 is determined as normal from the cross-sectional shape of the wire harness 200 having the minimum porosity extracted in step S270, the determination result is displayed on the display unit 150, and the process is ended. When the crimping of the crimp terminal 220 to the electric wire 210 is abnormal, the process proceeds to step S290.

In step S290, the image extracted in step S270 is rechecked. In the recheck of the image, an operator checks whether the extracted image is an image of the portion of the crimping portion 230 having minimum porosity, whether the extracted image overlaps with an image disposed adjacent to the crimping portion 230 of the wire harness 200 during imaging, and the like. As a result of the recheck, if the crimped state is normal, the crimped state is displayed as normal on the display unit 150, and the process is ended. As a result of the recheck, if the image is abnormal, the process proceeds to step S230 to reset the imaging conditions.

According to the crimping determination device 100 according to the present embodiment, the crimping portions 230 of a plurality of wire harnesses 200 may be imaged in one X-ray CT imaging process, and a large number of X-ray CT images of crimping portions 230 may be acquired in a short time. Therefore, it is possible to determine the quality of the crimped state of the crimping portions 230 in a time efficient manner. Further, since the wire harnesses 200 imaged by X-ray CT can be numbered, a wire harness 200 determined to be defective may be reliably collected.

With a jig 110 according to the present embodiment, it is possible to acquire an X-ray CT image in focus even when electric wires 210 of a plurality of wire harnesses 200 are being imaged. In the X-ray CT imaging, since the imaging is performed by focusing on one point, an in focus image may not be acquired if the vertical heights of the crimping portions 230 are not aligned. With the jig 110 according to the present embodiment, the height of the crimp terminals 220 may be aligned by providing the grooves D in the electric wire fixing portion 111, and since the height of the crimping portion 230 is also thereby aligned, an X-ray CT in focus image may be acquired for each crimping portion 230 held with the jig 110. Further, when the wire arranging portion 112 is used, it is possible to prevent portions other than the crimping portion 230 from being imaged in the X-ray CT process, so that the X-ray CT image of the crimping portion 230 may be captured with high accuracy. Further, since a groove D is provided in the electric wire fixing portion 111 of the jig 110, the individual electric wires 210 of wire harnesses 200 do not come into contact with each other when the crimping portions 230 are being imaged with X-rays, and thus, an image with high accuracy may be acquired.

According to the crimping determination method according to the present embodiment, it is possible to determine the crimped state quality of a crimping portion 230 without performing any special processing (only non-destructive testing is used) on the wire harness 200. Therefore, a wire harness 200 determined to be a non-defective product may be subsequently mounted on a product, and the reliability of the product on which the wire harness 200 is mounted may be improved. Further, by extracting an image having the minimum porosity, the image of the portion of the crimping portion 230 that is most crimped may be used to determine the crimped state quality. Further, since the images of a plurality of crimping portions 230 may be acquired in one imaging process, the quality of multiple crimping portions 230 may be determined more efficiently as compared with a case where an image of just a single crimping portion 230 is acquired in each imaging process. The time efficiency of the determination of the quality is improved, and the entire wire harness 200 may be inspected.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An electric wire fixing jig for X-ray CT imaging of a wire harness, the electric wire fixing jig comprising:
a base portion, the base portion being a material that transmits imaging X-rays; and
a groove extending depthwise in a first direction into a first surface of the base portion, the groove having a width in a second direction along the first surface of the base portion that is greater than a diameter of a wire of the wire harness, and the groove extends lengthwise in a third direction through a pair of facing outer surfaces of the base portion.

2. The electric wire fixing jig according to claim 1,
wherein the base portion is silicone rubber.

3. The electric wire fixing jig according to claim 1, further comprising:
a plurality of grooves, each extending depthwise in the first direction into the first surface of the base portion, each groove having a width in the second direction that is greater than a diameter of a wire of the wire harness, and each groove extends lengthwise in the third direction through the pair of facing outer surfaces of the base portion.

4. The electric wire fixing jig according to claim 3, wherein the plurality of grooves are spaced from each other in the second direction at the same interval.

5. The electric wire fixing jig according to claim 3, wherein the base portion is a flexible material.

6. The electric wire fixing jig according to claim 5, wherein the base portion can be rolled up along the second direction.

7. The electric wire fixing jig according to claim 5, further comprising:
a columnar support attached to the base portion on a back surface of the base portion opposite the first surface of the base portion into which the plurality of grooves are formed.

8. The electric wire fixing according to claim 7, wherein the columnar support is configured to attach to a stage of X-ray CT imaging device.

9. The electric wire fixing jig according to claim 7, further comprising:
a wiring arranging portion permitting wires of the wiring harness to be wound around a portion thereof.

10. The electric wire fixing jig according to claim 9, wherein the columnar support attaches to the wiring arranging portion.

11. The electric wire fixing jig according to claim 1, wherein the groove is triangular in cross-section.

12. The electric wire fixing jig according to claim 1, wherein
the base portion is a ring shape, and
the first surface of the base portion into which the groove extends depthwise is an inner surface of the ring shape.

13. The electric wire fixing jig according to claim 1, wherein the base portion is L-shaped.

14. The electric wire fixing jig according to claim 1, wherein
end surfaces of the base portion facing each other across the groove in the second direction are different sizes from each other in a plane parallel to the first and third directions.

15. The electric wire fixing jig according to claim 14, wherein a sidewall of the groove is a wavy surface.

16. The electric wire fixing jig according to claim 15, wherein the pair of facing outer surfaces are wavy surfaces.

17. The electric wire fixing jig according to claim 1, further comprising:
numbering on the base portion, the numbering being a material through which X-rays penetrate less than the base portion.

18. A crimping state determination device, comprising:
an imaging unit that emits X-rays;
an electric wire fixing jig including:
a base portion, the base portion being a material that transmits imaging X-rays; and
a groove extending depthwise in a first direction into a first surface of the base portion, the groove having a width in a second direction along the first surface of the base portion that is greater than a diameter of a wire of the wire harness, and the groove extends lengthwise in a third direction through a pair of facing outer surfaces of the base portion; and
a determination unit that identifies a quality of a crimping state of a wire harness in the electric wire fixing jig based on an image captured by the imaging unit.

19. A crimping determination method for determining a quality of a crimping state of a wire harness, the method comprising:
acquiring X-ray CT images by performing X-ray CT imaging on a crimp terminal portion of a wire harness, the wire harness being fixed in an electric wire fixing jig for X-ray CT imaging, the electric wire fixing jig including:
a base portion, the base portion being a material that transmits imaging X-rays, and
a groove extending depthwise in a first direction into a first surface of the base portion, the groove having a width in a second direction along the first surface of the base portion that is greater than a diameter of a wire of the wire harness, and the groove extends lengthwise in a third direction through a pair of facing outer surfaces of the base portion;
extracting a plurality of X-ray CT images of the crimp terminal portion of the wire harness from the X-ray CT images;
calculating a porosity of the crimp terminal portion from the plurality of extracted X-ray CT images;
selecting an X-ray CT image in which the calculated porosity of the crimp terminal portion is a minimum porosity; and
determining a quality of a crimping state of the crimp terminal portion based on the selected X-ray CT image.
